(19) United States
(12) Patent Application Publication
(10) Pub. No.: US 2016/0132251 A1
(43) Pub. Date: May 12, 2016

(54) OPERATING METHOD OF STORAGE DEVICE AND DATA WRITING METHOD FOR WRITING DATA INTO STORAGE DEVICE

(71) Applicant: SAMSUNG ELECTRONICS CO., LTD., Suwon-si (KR)

(72) Inventors: JOOYOUNG HWANG, SUWON-SI (KR); ANDREA ARPACI-DUSSEAU, MADISON, WI (US); REMZI ARPACI-DUSSEAU, MADISON, WI (US); THANUMALAYAN SANKARANARAYANA PILLAI, MADISON, WI (US); VIJAYCHIDAMBARAM VELAYUDHAN PILLAI, MADISON, WI (US)

(73) Assignee: WISCONSIN ALUMNI RESEARCH FOUNDATION, MADISON, WI (US)

(21) Appl. No.: 14/837,520

(22) Filed: Aug. 27, 2015

Related U.S. Application Data
(60) Provisional application No. 62/078,294, filed on Nov. 11, 2014.

(51) Int. Cl. G06F 3/06

(52) U.S. Cl. CPC G06F 3/0605; G06F 3/0647; G06F 3/0685

(57) ABSTRACT

An operating method of a storage device is provided which includes receiving a plurality of write requests and executing write operations in response to the plurality of write requests. Progress information on the degree of progress of the write operations is output while the write operations corresponding to the plurality of write requests are performed.

### CROSS-REFERENCE TO RELATED APPLICATIONS

This U.S. non-provisional patent application claims priority under U.S.C. 119(e) from U.S. provisional patent application No. 62/078,294, filed on Nov. 11, 2014, the entire contents of which are hereby incorporated by reference.

### BACKGROUND

The technology described herein relates to a storage device, and more particularly, relates to an operating method of the storage device and a method of writing data at the storage device.

A storage device is a device that stores data according to a control of a host device, such as a computer, a smart phone, and a smart pad. The storage device may contain a device (e.g., Hard Disk Drive), which stores data on a magnetic disk, or a semiconductor memory, such as a Solid State Drive or memory card, in particular, a device which stores data on a nonvolatile memory.

A nonvolatile memory may be ROM (Read Only Memory), PROM (Programmable ROM), EPROM (Electrically Programmable ROM), EEPROM (Electrically Erasable and Programmable ROM), flash memory, PRAM (Phase-change RAM), MRAM (Magnetic RAM), RRAM (Resistive RAM), or FRAM (Ferroelectric RAM).

The advancement of the semiconductor fabrication technology may enable improvement of an operating speed of a host device (e.g., a computer, a smart phone, or a smart pad) that communicates with a storage device. The capacity of contents that are used in the storage device and a host device of the storage device is increasing with time. Thus, improvement of operating speed of the storage device is increasingly required.

### SUMMARY

One aspect of embodiments of the disclosure is directed to provide an operating method of a storage device comprising receiving a plurality of write requests; and executing write operations in response to the plurality of write requests, wherein progress information on the degree of progress of the write operations is output while the write operations corresponding to the plurality of write requests are performed.

In exemplary embodiments, the plurality of write requests include a plurality of sequence numbers corresponding to the plurality of write requests.

In exemplary embodiments, the progress information comprises a sequence number of an oldest write request, not yet performed, from among the plurality of write requests.

In exemplary embodiments, when the oldest pending write request is performed, the sequence number corresponding thereto is output as the progress information.

In exemplary embodiments, the progress information comprises a sequence number of a write request, most recently performed, from among the plurality of write requests.

In exemplary embodiments, upon performing each of the plurality of write requests, the sequence number corresponding thereto is output as the progress information.

In exemplary embodiments, the operating method further comprises receiving a target sequence number. When a sequence number corresponding to a most recently performed write request is the same as the target sequence number, an interrupt indicating the sameness is output as the progress information.

In exemplary embodiments, at least one of the plurality of write requests comprises a sequence number.

In exemplary embodiments, when a write operation corresponding to the at least one write request having the sequence number is performed, the sequence number is output as the progress information.

In exemplary embodiments, the progress information is output in response to a read request received from an external device.

Another aspect of embodiments of the disclosure is directed to provide a method of writing data at a storage device. The method comprises transmitting a write request on first sequence data to the storage device; and transmitting a write request on second sequence data to the storage device in response to an input of progress information indicating that a write operation on the first sequence data ends. The first sequence data is data that has to be written at the storage device earlier than the second sequence data. A read operation, in which data is read from the storage device, or a write operation, in which non-sequence data is written at the storage device, is conducted until the write operation of the first sequence data ends, and wherein the non-sequence data is data that is to be written at the storage device regardless of an order.

In exemplary embodiments, each of write requests transmitted to the storage device includes a sequence number. When the progress information includes a sequence number of a write request of the first sequence data, the write operation of the first sequence data is determined as being completed.

In exemplary embodiments, each of write requests transmitted to the storage device includes a sequence number. When a value of the progress information is equal to or greater than a sequence number of a write request on the first sequence data, the write operation of the first sequence data is determined as being completed.

In exemplary embodiments, a write request, associated with the first sequence data, from among write requests transmitted to the storage device includes a sequence number. When the progress information includes a sequence number of the write request of the first sequence data, the write operation of the first sequence data is determined as being completed.

In exemplary embodiments, the progress information is acquired by sending a read request on the progress information periodically.

Another aspect of embodiments of the disclosure is directed to provide a method, executed by a host computing device, of writing sequential data to a nonvolatile memory. The method includes transmitting, to a memory controller of the nonvolatile memory, a write request comprising first data and first sequence information assigned to the first data, the first data being selected from among the first data and second data that must be written to the nonvolatile memory in the order of the first data and then the second data. Second sequence information is received from the memory controller identifying data that has been written to the nonvolatile memory by the memory controller. A determination is made that the first data has been written to the nonvolatile memory when the second sequence information so indicates.

In exemplary embodiments, transmission, to the memory controller, of another write request comprising the second data is withheld until a determination is made that the first data has been written to the nonvolatile memory.

In exemplary embodiments, the method includes transmitting, to the memory controller, another write request comprising third data before a determination is made that the first data has been written to the nonvolatile memory. The third data need not be written to the nonvolatile memory in a particular order with respect to the first data.

In exemplary embodiments, the method includes transmitting a request for the second sequence information to the memory controller.

In exemplary embodiments, the second sequence information is an interrupt signal.

Another aspect of embodiments of the disclosure is directed to provide a method, executed by a memory controller, of writing sequential data to a nonvolatile memory. The method includes a) receiving, from a host computing device, a write request comprising first data and sequence information assigned to the first data, the first data being selected from among the first data and second data that must be written to the nonvolatile memory in the order of the first data and then the second data; b) writing the first data to the nonvolatile memory; and c) transmitting, to the host computing device, an indication that the first data has been written to the nonvolatile memory.

In exemplary embodiments, the indication is an interrupt signal.

In exemplary embodiments, the indication comprises the sequence information.

In exemplary embodiments, the set of operations (a) through (c) are performed for each of multiple hosts.

Another aspect of embodiments of the disclosure is directed to provide a computer host having a transmitter that transmits, to a memory controller of a nonvolatile memory, a write request comprising first data and first sequence information assigned to the first data, the first data being selected from among the first data and second data that must be written to the nonvolatile memory in the order of the first data and then the second data. A receiver receives, from the memory controller, second sequence information identifying data that has been written to the nonvolatile memory by the memory controller. A processor determines that the first data has been written to the nonvolatile memory when the second sequence information so indicates.

In exemplary embodiments, the processor withholds the transmission, to the memory controller via the transmitter, of another write request comprising the second data until a determination is made that the first data has been written to the nonvolatile memory.

In exemplary embodiments, the processor controls the transmitter to transmit, to the memory controller, another write request comprising third data before a determination is made that the first data has been written to the nonvolatile memory. The third data need not be written to the nonvolatile memory in a particular order with respect to the first data.

In exemplary embodiments, the processor controls the transmitter to transmit a request for the second sequence information to the memory controller.

In exemplary embodiments, the second sequence information is an interrupt signal.

Another aspect of embodiments of the disclosure is directed to provide a memory controller of a nonvolatile memory. The memory controller includes a receiver that receives, from a host computing device, a write request comprising first data and sequence information assigned to the first data, the first data being selected from among the first data and second data that must be written to the nonvolatile memory in the order of the first data and then the second data. A memory interface writes the first data to the nonvolatile memory. A transmitter transmits, to the host computing device, an indication that the first data has been written to the nonvolatile memory.

In exemplary embodiments, the indication is an interrupt signal.

In exemplary embodiments, the indication comprises the sequence information.

In exemplary embodiments, the receiver receives, from another host computing device, another write request comprising third data and other sequence information assigned to the third data, the third data being selected from among the third data and fourth data that must be written to the nonvolatile memory in the order of the third data and then the fourth data. The memory interface writes the third data to the nonvolatile memory. The transmitter transmits, to the other host computing device, an indication that the third data has been written to the nonvolatile memory.

With embodiments of the disclosure, an order of a plurality of sequence data is guaranteed without a flush operation. Thus, a time is not required to perform the flush operation.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram schematically illustrating a computing device according to an embodiment of the disclosure;

FIG. 2 is a block diagram schematically illustrating an operating method of a host device according to an embodiment of the disclosure;

FIG. 3 is a flow chart schematically illustrating an operating method of a storage device according to an embodiment of the disclosure;

FIG. 4 is a block diagram schematically illustrating a storage device according to an embodiment of the disclosure;

FIG. 5 shows a method in which a host device transmits a write request on sequence data to a storage device;

FIG. 6 is a timing diagram schematically illustrating an operation of a storage device depending on write requests registered at a queue;

FIG. 7 shows a method in which there is determined whether writing of sequence data is completed, according to an embodiment of the disclosure;

FIG. 8 shows a method in which there is determined whether a writing of sequence data is completed, according to a second embodiment of the disclosure;

FIG. 9 shows a method in which there is determined whether writing of sequence data is completed, according to a third embodiment of the disclosure;

FIG. 10 shows a method in which there is determined whether writing of sequence data is completed, according to a fourth embodiment of the disclosure;

FIG. 11 shows a method in which a host device transmits a write request of sequence data to a storage device, according to a second embodiment of the disclosure;

FIG. 12 shows another embodiment in which sequence numbers are assigned to sequence data;

FIG. 13 shows another embodiment in which sequence numbers are assigned to sequence data;

FIG. 14 shows another embodiment of write requests registered at a queue;

FIG. 15 shows still another embodiment of write requests registered at a queue;

FIG. 16 is a flow chart schematically illustrating an operating method of a host device, according to another embodiment of the disclosure;

FIG. 17 is a block diagram schematically illustrating a nonvolatile memory according to an embodiment of the disclosure;

FIG. 18 is a circuit diagram schematically illustrating a memory block according to an embodiment of the disclosure;

FIG. 19 is a circuit diagram schematically illustrating a memory block according to another embodiment of the disclosure;

FIG. 20 is a block diagram schematically illustrating a memory controller according to an embodiment of the disclosure; and

FIG. 21 is a block diagram schematically illustrating a computing device according to an embodiment of the disclosure.

### DETAILED DESCRIPTION

Embodiments will be described in detail with reference to the accompanying drawings. The disclosure, however, may be embodied in various different forms, and should not be construed as being limited only to the illustrated embodiments. Rather, these embodiments are provided as examples so that this disclosure will be thorough and complete, and will fully convey the concept of the disclosure to those skilled in the art. Accordingly, known processes, elements, and techniques are not described with respect to some of the embodiments of the disclosure. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the disclosure.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

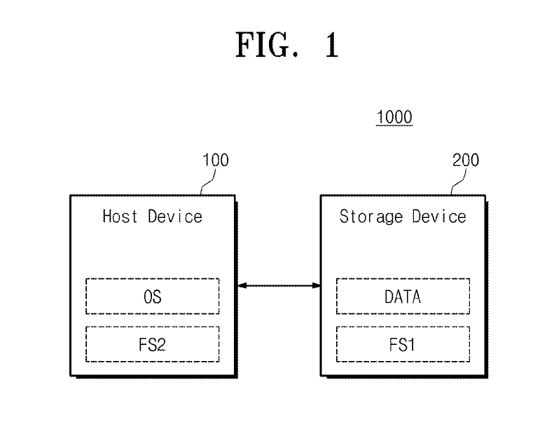

FIG. 1 is a block diagram schematically illustrating a computing device 1000 according to an embodiment of the disclosure. Referring to FIG. 1, a computing device 1000 contains a host device 100 and a storage device 200.

The host device 100 stores data at the storage device 200 and reads data from the storage device 200. The host device 100 may include at least one of various electronic devices, such as a computer, a smart phone, a smart pad, and a smart television.

The storage device 200 performs an operation of writing, reading or erasing data according to a request of the host device. The storage device 200 may include a solid state drive (SSD) or a hard disk drive (HDD). The storage device 200 may include memory cards, such as a PC card (PCMCIA, personal computer memory card international association), a compact flash card, a smart media card (SM, SMC), a memory stick, a multimedia card (MMC, RS-MMC, MMCmicro), an SD card (SD, miniSD, microSD, SDHC), a USB (Universal Serial Bus) memory card, and a universal flash storage (UFS). The storage device 100 may include embedded memories, such as eMMC (embedded MultiMedia Card), UFS, and PPN (Perfect Page New).

The storage device 200 stores data and a first file system FS1. The data may include user data written at the storage device 200 in response to a request of the host device 100. The first file system FS1 may be metadata for managing files that have been stored at the storage device 200.

The host device 100 executes an operating system OS. The operating system OS may be loaded on the host device 100 from the storage device 200 or any other storage medium. The operating system OS manages a second file system FS2 for managing the storage device 200. For example, the operating system OS reads the first file system FS1 from the storage device 200 and uses it as the second file system FS2. If the second file system FS2 is updated, updated data may be reflected to the first file system FS1 of the storage device 200. For example, the operating system OS flushes a change (e.g., the updated data) in the second file system FS2 into the storage device 200 such that consistency between the first file system FS1 and the second file system FS2 is maintained.

The operating system OS accesses the storage device 200, depending on the second file system FS2. The operating system OS conducts data reading and writing operations on the storage device 200, depending on the second file system FS2.

A portion of data that the operating system OS writes at the storage device 200 may be sequence data. The sequence data may be data that will be written in a given order. For example, it is assumed that first data, second data, and third data are sequence data, respectively. With this assumption, the second data must be written at the storage device 200 after the first data is written at the storage device 200, and the third data must be written at the storage device 200 after the second data is written at the storage device 200.

For example, journaling data may be sequence data. The journaling data may be data used when the operating system OS updates the first file system FS1 stored at the storage device 200. Before updating the first file system FS1, the operating system OS writes, at the storage device 200, information on an update history of the first file system FS1, for example, information associated with an address to be updated and data to be updated, as the journaling data. After writing of the journaling data ends, the operating system OS updates the first file system FS1. If the journaling data is written, the first file system FS1 may be successfully updated referring to the journaling data though sudden power-off (SPO) occurs while the first file system FS1 is updated.

As described above, the journaling data has to written at the storage device 200 earlier than updated data of the first file system FS1. The journaling data may include a plurality of data blocks, and a write order of the plurality of data blocks has to be guaranteed. That is, the data blocks composing journaling data may also be sequence data.

The host device 100 and the storage device 200 are configured to guarantee an order of a plurality of sequence data, depending on methods to be described later.

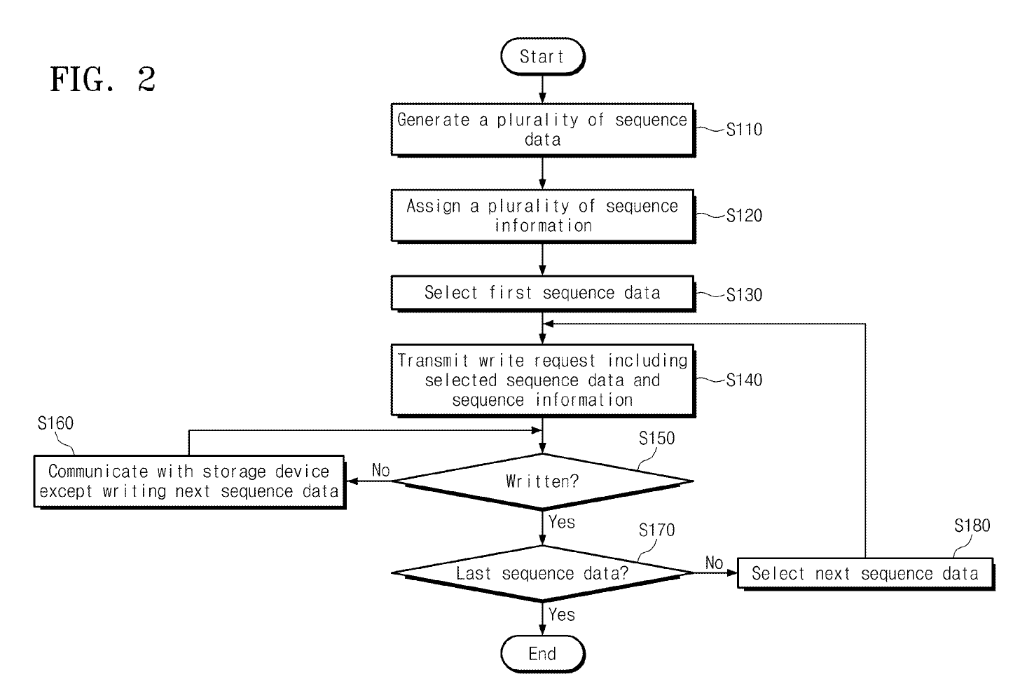

FIG. 2 is a block diagram schematically illustrating an operating method of a host device 100 according to an embodiment of the disclosure. Referring to FIGS. 1 and 2, in step S110, a host device 100 generates a plurality of sequence data.

In step S120, the host device 100 assigns a plurality of sequence information to the plurality of sequence data, respectively. The plurality of sequence information may include information on an order of the plurality of sequence data. For example, the plurality of sequence information may be sequence numbers respectively assigned to the plurality of sequence data.

In step S130, the host device 100 selects a first one of the plurality of sequence data.

In step S140, the host device 100 transmits, to a storage device 200, a write request including the selected sequence data and sequence information assigned to the selected sequence data.

In step S150, the host device 100 determines whether writing of the sequence data at the storage device 200 ends. For example, whether writing of the sequence data at the storage device 200 ends may be determined depending on information received from the storage device 200.

As a consequence of determining that writing of the sequence data at the storage device 200 does not end, in step S160, the host device 100 communicates with the storage device 200 without writing next sequence data. For example, the host device 100 sends a read request to the storage device 200 or a write request of non-sequence data to the storage device 200. Until writing of the sequence data ends, the host device 100 waits while performing any other operation except writing sequence data at the storage device 200.

If writing of the sequence data ends, in step S170, the host device 100 determines whether the written sequence data is the last sequence data. As a consequence of determining that the written sequence data is not the last sequence data, the method proceeds to step S180, in which next sequence data of the plurality of sequence data is selected. Afterwards, the method proceeds to step S140. If the written sequence data is the last sequence data, an operation of the host device transmitting a plurality of sequence data to the storage device 200 may be terminated.

Afterwards, the host device 100 may perform a write or read operation of non-sequence data or write operations of another set of sequence data.

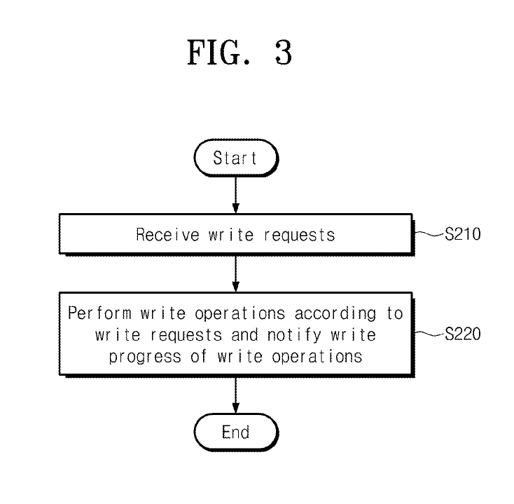

FIG. 3 is a flow chart schematically illustrating an operating method of a storage device 200 according to an embodiment of the disclosure. Referring to FIGS. 1 and 3, in step S210, a storage device 200 receives a plurality of write requests. The plurality of write requests may include the following: write requests associated with sequence data and non-sequence data.

In step S220, the storage device 200 performs write operations corresponding to the plurality of write requests and notifies the host device 100 of write progress on the plurality of write requests.

As described with reference to FIGS. 2 and 3, the host device 100 adds sequence information to sequence data and sends a write request to the storage device 200. The storage device 200 notifies the host device 100 of write progress of write requests received from the host device 100. The host device 100 determines whether writing of the sequence data ends, depending on information from the storage device 200. If writing of sequence data ends, the host device 100 transmits a write request on next sequence data to the storage device 200.

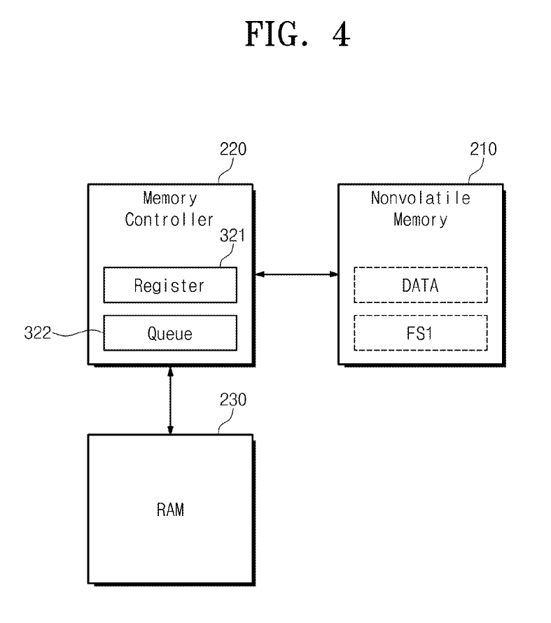

FIG. 4 is a block diagram schematically illustrating a storage device 200 according to an embodiment of the disclosure. Referring to FIG. 4, a storage device 200 contains a nonvolatile memory 210, a memory controller 220, and a RAM 230. For the sake of easy understanding, an embodiment of the disclosure is exemplified in FIG. 4 as the storage device 200 includes a nonvolatile memory 210. That is, it is assumed that the storage device 200 forms a solid state drive, a memory card, or an embedded memory. However, the nonvolatile memory 210 of the storage device 200 may be replaced with a magnetic disk. That is, the storage device 200 may form a hard disk drive (HDD).

The nonvolatile memory 210 performs read, write, and erase operations according to a control of the memory controller 220. The nonvolatile memory 210 may include a flash memory. However, the disclosure is not limited thereto. For example, the nonvolatile memory 210 may incorporate at least one of nonvolatile memories, such as PRAM (Phase-change RAM), MRAM (Magnetic RAM), RRAM (Resistive RAM), and FeRAM (Ferroelectric RAM).

The nonvolatile memory 210 stores data and a first file system FS1 described with reference to FIG. 1.

The memory controller 220 controls the nonvolatile memory 210 in response to a request of a host device 100 or depending on a predetermined schedule. For example, the nonvolatile memory 210 performs a write, read, or erase operation under the control of the memory controller 220. The memory controller 220 informs the host device 100 of write progress of write requests.

The memory controller 220 contains a register 321 and a queue 322. The memory controller 220 stores the write progress of the write requests at the register 321. The memory controller 220 manages write requests from the host device 100 by means of the queue 322. The memory controller 220 rearranges orders of write requests enqueued in the queue 322. The memory controller 220 enqueues the rearranged orders of the write requests in the queue 322.

The memory controller 220 uses the RAM 230 as a working memory, a buffer memory, or a cache memory. For example, the memory controller 220 receives data from the host device 100 and stores the received data in the RAM 230. The memory controller 220 writes the data stored in the RAM 230 to the nonvolatile memory 210. The memory controller 220 reads data from the nonvolatile memory 210 and stores the read data in the RAM 230. The memory controller 220 outputs data stored in the RAM 230 to the host device 100. The memory controller 220 stores data read from the nonvolatile memory 210 in the RAM 230 and writes the data stored in the RAM 230 back to the nonvolatile memory 210. In exemplary embodiments, data of write requests registered in the queue 322 may be managed on the RAM 230.

The memory controller 220 stores data or codes, needed to manage the nonvolatile memory 210, at the RAM 230. For example, the memory controller 220 reads data or codes, needed to manage the nonvolatile memory 210, from the nonvolatile memory 210 and loads the read data or codes on the RAM 230 for execution.

The RAM 230 may include at least one of a variety of random access memories, such as, but not limited to, a static RAM, a dynamic RAM, a synchronous DRAM (SRAM), a Phase-change RAM (PRAM), a Magnetic RAM (MRAM), a Resistive RAM (RRAM), and a Ferroelectric RAM (FRAM).

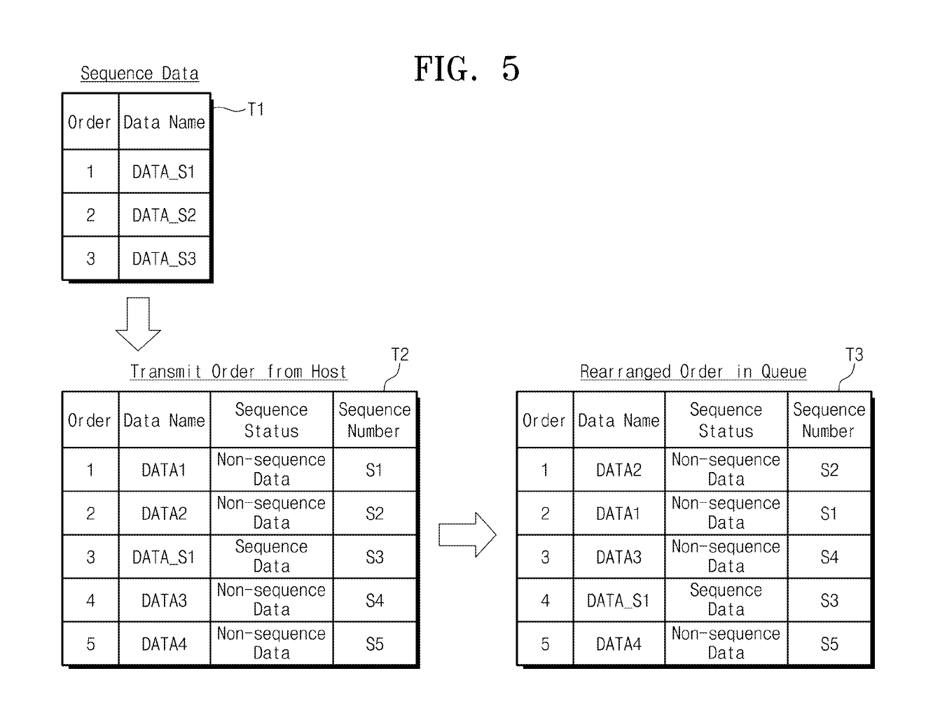

FIG. 5 shows a method in which a host device 100 transmits a write request on sequence data to a storage device 200. Referring to FIGS. 1, 4, and 5, as illustrated in a first table T1, a host device 100 generates first sequence data DATA_S1, second sequence data DATA_S2, and third sequence data DATA_S3. The first sequence data DATA_S1 is data that has to be written at a storage device 200 earlier than the second sequence data DATA_S2. The second sequence data DATA_S2 is data that has to be written at the storage device 200 earlier than the third sequence data DATA_S3.

As illustrated in a second table T2, the host device 100 provides the storage device 200 with a plurality of write requests including a write request on the first sequence data DATA_S1. The host device 100 assigns sequence numbers to all write requests transmitted to the storage device 200.

First of all, the host device 100 transmits a write request on first data DATA1 being non-sequence data to the storage device 200. A first sequence number S1 is assigned to the first data DATA1 which is first of all transmitted.

Next, the host device 100 transmits a write request on second data DATA2 being non-sequence data to the storage device 200. A second sequence number S2 is assigned to the second data DATA2.

Then, the host device 100 transmits a write request on first sequence data DATA1_S1 to the storage device 200. A third sequence number S3 is assigned to the first sequence data DATA1_S1.

Afterwards, the host device 100 transmits a write request, including third data DATA3 being non-sequence data and a fourth sequence number S4, to the storage device 200. Later, the host device 100 transmits a write request, including fourth data DATA4 being non-sequence data and a fifth sequence number S5, to the storage device 200.

As described with reference to FIGS. 2 and 3, the host device 100 conducts normal communications with the storage device 200 while sequentially transmitting write requests on sequence data to the storage device 200. As illustrated in the second table T2, a write request on the first sequence data DATA_S1 may be transmitted among write requests on the first through fourth data DATA1 through DATA4.

Referring to a third table T3, write requests transmitted from the host device 100 are rearranged, and the rearranged write requests are registered at a queue 322. For example, the write requests may be registered at the queue 322 in order of second data DATA2, first data DATA1, third data DATA3, first sequence data DATA_S1, and fourth data DATA4. The storage device 200 carries out write operations in order of the second data DATA2, first data DATA1, third data DATA3, first sequence data DATA_S1, and fourth data DATA4, depending on the write requests registered at the queue 322.

The memory controller 220 may store write progress of the write requests at a register 321 while performing the write requests registered at the queue 322. For example, the memory controller 220 may store, as a first value R1, a sequence number of the oldest write request among the write requests registered at the queue 322 at the register 321. The memory controller 220 may store a sequence number of the most recently completed write request at the register 321 as a second value R2. The memory controller 220 provides the host device 100 with the first value R1 or the second value R2 stored in the register 321 randomly or in response to a request of the host device 100.

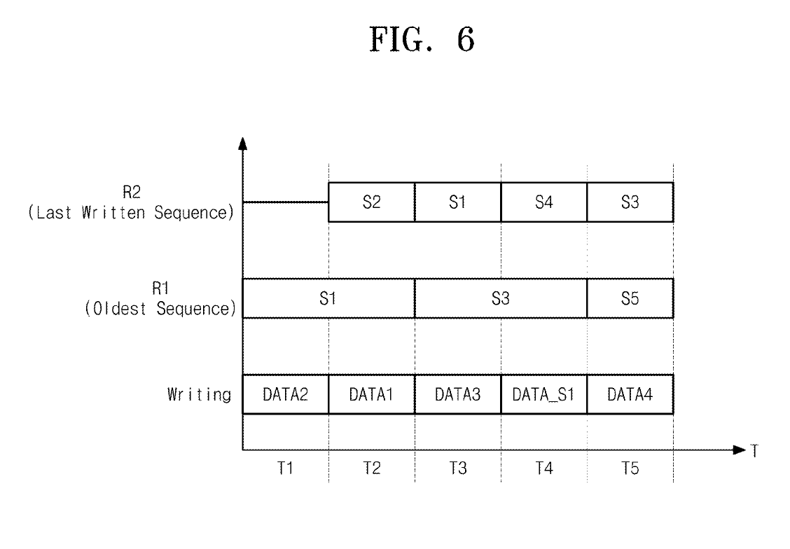

FIG. 6 is a timing diagram schematically illustrating an operation of a storage device 200 depending on write requests registered at a queue 322. Referring to FIGS. 1 and 4 through 6, during a first section T1, a storage device 200 performs a write operation on second data DATA2, depending on a write request on the second data DATA2 registered at a first slot of a queue 322.

Sequence numbers of write requests denote orders of the write requests transmitted from a host device 100. That is, a write request that has a sequence number lower than a sequence number of any other write request may be a write request that is registered at the queue 322 earlier than any other write request. In the first section T1, the oldest write request of the write requests registered at the queue 322 is a write request having a first sequence number S1. Thus, a first value R1 of a register 321 has the first sequence number S1.

If a write operation on the second data DATA2 is completed, in a second section T2, a second value R2 of the register 321 may be updated to have a sequence number S2 of the second data DATA2. If a write operation on the second data DATA2 is completed, a write request on the second data DATA2 is released from the queue 322.

In the second section T2, the storage device 200 performs a write operation on first data DATA1 in response to a write request on the first data DATA1 registered at a next slot of the queue 322. If a write operation on the first data DATA1 is completed, in a third section T3, the second value R2 of the register 321 may be updated to have a sequence number S1 of the first data DATA1. If a write operation on the first data DATA1 is completed, a write request on the first data DATA1 is released from the queue 322. Thus, now that the lowest sequence number of the sequence numbers registered at the queue 322 may be a third sequence number S3, the first value R1 of the register 321 is updated to have the third sequence number S3.

In the third section T3, the storage device 200 performs a write operation on third data DATA3 in response to a write request on the third data DATA3 registered at a next slot of the queue 322. If a write operation on the third data DATA3 is completed, the second value R2 of the register 321 is updated to have a fourth sequence number S4 corresponding to the third data DATA3.

In a fourth section T4, the storage device 200 performs a write operation on first sequence data DATA_S1 in response to a write request on the first sequence data DATA_S1 registered at a next slot of the queue 322.

If a write operation on the first sequence data DATA_S1 is completed, in a fifth section T5, the second value R2 of the register 321 may be updated to have a third sequence number S3 of the first sequence data DATA_S1. If a write operation on the first sequence data DATA_S1 is completed, a write request on the first sequence data DATA_S1 is released from the queue 322. Since the lowest sequence number of the sequence numbers registered at the queue 322 is a fifth sequence number S5, the first value R1 of the register 321 is updated to have the fifth sequence number S5.

In the fifth section T5, the storage device 200 performs a write operation on fourth data DATA4 in response to a write request on the fourth data DATA4 registered at a next slot of the queue 322.

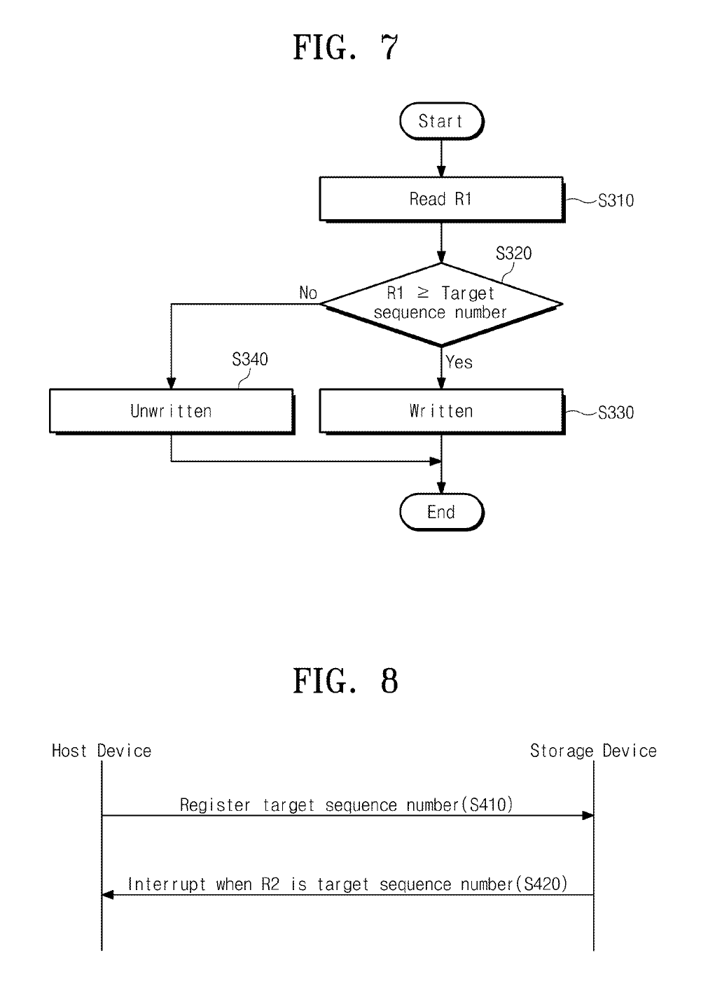

FIG. 7 shows a method for determining whether the writing of sequence data is completed, according to an embodiment of the disclosure. Referring to FIGS. 1, 4, 6, and 7, in step S310, a host device 100 reads a first value R1 of queue 322. For example, the host device 100 sends a read request on the first value R1 to a memory controller 220 and receives the first value R1 from the memory controller 220.

In step S320, the host device 100 determines whether a sequence number of the first value R1 is greater than or equal to a target sequence number. For example, the target sequence number may be a sequence number assigned to sequence data. First sequence data DATA_S1 has a third sequence number S3. Thus, the host device 100 determines whether the first value R1 is equal to or greater than the third sequence number S3.

As a consequence of determining that the first value R1 is equal to or greater than the third sequence number S3, in step S330, there is determined that writing of the sequence data is completed. If the first value R1 is smaller than the target sequence number, in step S340, there is determined that writing of the sequence data is not completed.

For example, in a fourth section T4 of FIG. 6, the first value R1 has a third sequence number S3. In a fifth section T5, the first value R1 has a fifth sequence number S5. When reading the first value R1 in the fourth section T4 or before the fourth section T4, the host device 100 determines that writing of first sequence data DATA_S1 is not completed. When reading the first value R1 in the fifth section T5 or after the fifth section T5, the host device 100 determines that writing of first sequence data DATA_S1 is completed.

In exemplary embodiments, the host device 100 may read the first value R1 periodically until the first value R1 becomes equal to or greater than the target sequence number. That is, steps S150 and S160 of FIG. 2 are periodically performed.

FIG. 8 shows a method in which whether writing of sequence data is completed is determined, according to a second embodiment of the disclosure. Referring to FIGS. 1, 4, 6, and 8, in step S410, a host device 100 transmits a target sequence number to a storage device 200. The target sequence number may be a sequence number assigned to sequence data. That is, the host device 100 sends a third sequence number S3 to the storage device 200. The storage device 200 stores the target sequence number received from the host device 100. For example, the storage device 200 may store the target sequence number at a register 321 or a RAM 230 of a memory controller 220.

In step S420, the storage device 200 sends an interrupt to the host device 100 when a second value R2 reaches the target sequence number. For example, in a fifth section T5 of FIG. 6, the second value R2 of the register 321 is update to have a third sequence number S3. Thus, the memory controller 220 issues an interrupt to the host device 100 in the fifth section T5. In response to the transmitted interrupt, the host device 100 determines that writing of sequence data is completed.

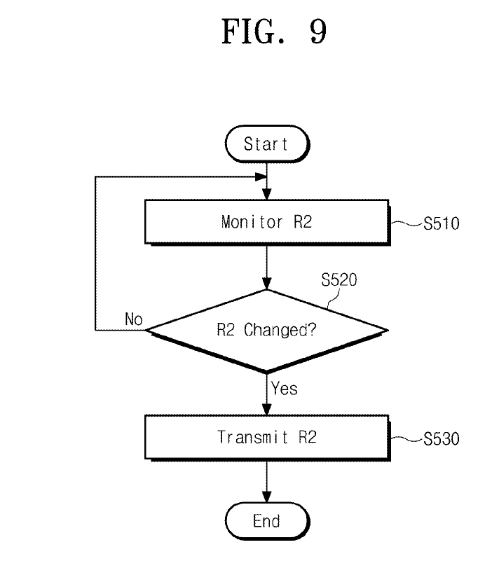

FIG. 9 shows a method in which whether writing of sequence data is completed is determined, according to a third embodiment of the disclosure. Referring to FIGS. 1, 4, 6, and 9, in step S510, a memory controller 220 monitors a second value R2 of a register 321.

In step S520, there is determined whether the second value R2 of the register 321 is changed. If so, in step S530, the memory controller transmits the second value R2 to a host device 100 whenever the second value R2 is changed. The memory controller sends the second value R2 thus changed to the host device 100 whenever a write operation corresponding to a write request registered at one slot of a queue 322 is completed.

The host device 100 compares the second value R2 with the target sequence number. When the second value R2 is equal to the target sequence number, the host device 100 determines that writing of the sequence data is completed.

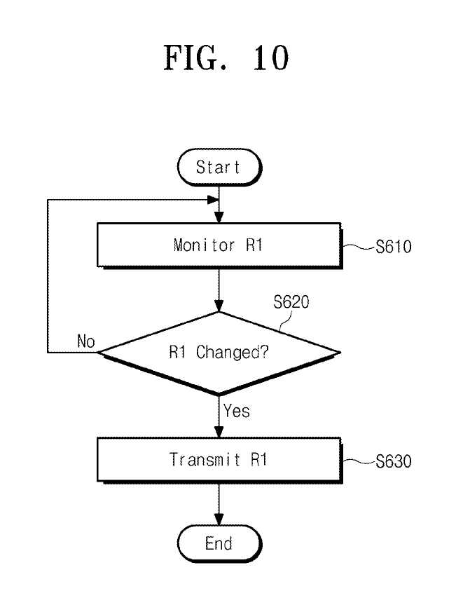

FIG. 10 shows a method for determining whether the writing of sequence data is completed, according to a fourth embodiment of the disclosure. Referring to FIGS. 1, 4, 6, and 10, in step S610, a memory controller 220 monitors a first value R1 of queue 322.

In step S620, there is determined whether the first value R1 of the queue 321 is changed. If so, in step S630, the memory controller 220 transmits the first value R1 to a host device 100 whenever the first value R1 is changed.

For example, the first value R1 may be changed in third and fifth sections T3 and T5 of FIG. 6. Thus, in the third and fifth sections T3 and T5, the memory controller 220 sends the first value R1 thus changed to the host device 100.

The host device 100 compares the first value R1 with the target sequence number. When the first value R1 is equal to or greater than the target sequence number, the host device 100 determines that writing of the sequence data is completed.

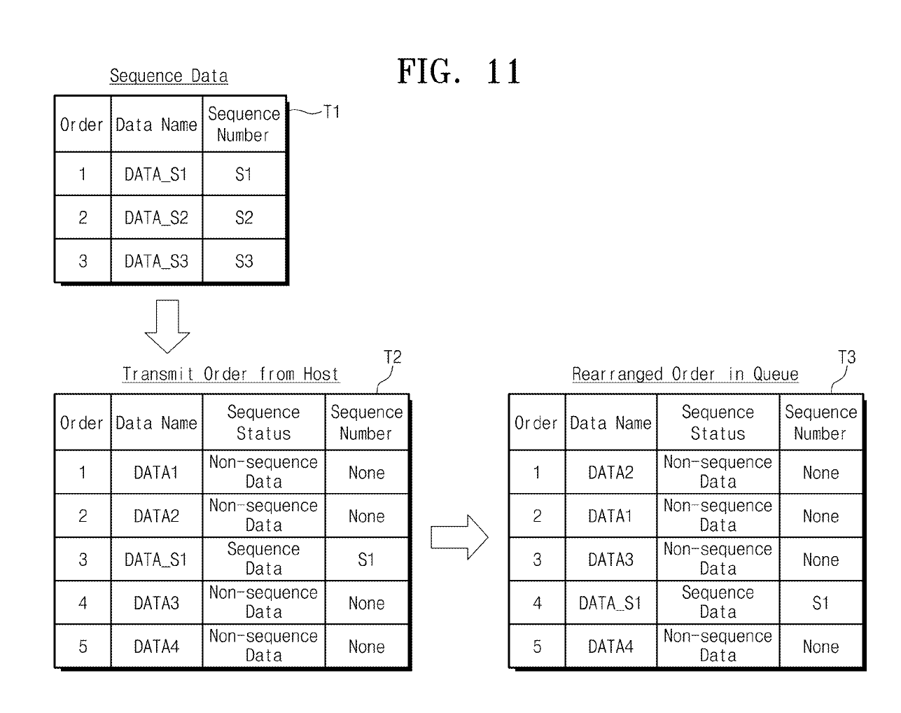

FIG. 11 shows a method in which a host device transmits a write request on sequence data to a storage device, according to a second embodiment of the disclosure. In FIG. 11, a method is different from that shown in FIG. 5 in that sequence numbers are assigned not to non-sequence data but only to sequence data.

As illustrated in a first table T1, sequence numbers are assigned when first sequence data DATA_S1, second sequence data DATA_S2, and third sequence data DATA_S3 are generated. A first sequence number S1, a second sequence number S2, and a third sequence number S3 are assigned to the first sequence data DATA_S1, the second sequence data DATA_S2, and the third sequence data DATA_S3, respectively. As another embodiment, sequence numbers may be assigned when sequence data selected by a host device 100 is transmitted.

As illustrated in a second table T2, write requests on first through fourth data DATA1 through DATA4 being non-sequence data are transmitted without sequence numbers. A write request on first sequence data DATA_S1 is transferred together with a first sequence number S1.

Referring to a third table T3, the write requests on the first through fourth data DATA1 through DATA4 being non-sequence data are managed in a queue 322 of a memory controller 220 without sequence numbers. A write request on the first sequence data DATA_S1 is managed together with the first sequence number S1.

In exemplary embodiments, the memory controller 220 may manage a second value R2 and may not manage a first value R1. For example, the memory controller 220 may not generate and store the first value R1.

In a way similar to that described with reference to FIG. 7, a host device 100 reads the second value R2 of the register 321 from the memory controller 220. The host device 100 determines whether the second value R2 of the register 321 is equal to a target sequence number. If the second value R2 of the register 321 is equal to the target sequence number, the host device 100 may determine that writing of the first sequence data DATA_S1 is completed.

As another embodiment, as described with reference to FIG. 9, whenever a second value R2 is changed, the memory controller 220 provides the host device 100 with the second value R2 thus changed. If the second value R2 received is equal to the target sequence number, the host device 100 may determine that writing of the first sequence data DATA_S1 is completed.

As still another embodiment, in a way similar to that described with reference to FIGS. 8 and 9, the memory controller 220 issues an interrupt to the host device 100 whenever the second value R2 is changed. In response to the interrupt, the host device determines that writing of the first sequence data DATA_S1 is completed.

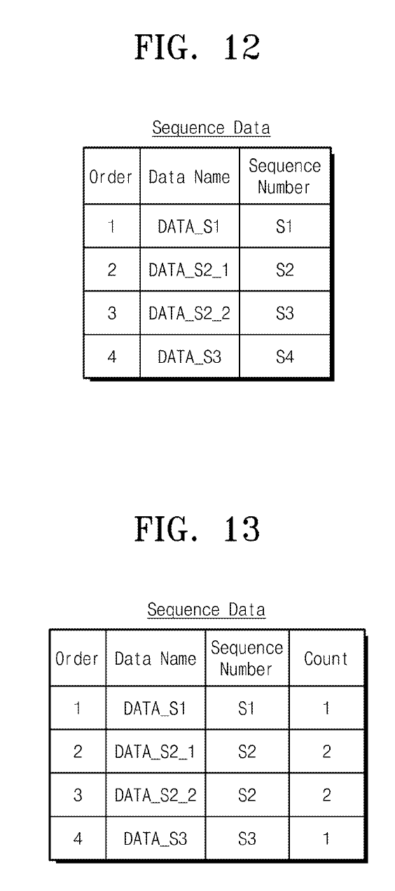

FIG. 12 shows another embodiment in which sequence numbers are assigned to sequence data. Referring to FIGS. 1, 4, and 12, first sequence data DATA_S1 is data that has to be written earlier than second sequence data DATA_S2_1 and DATA_S2_2. The second sequence data DATA_S2_1 and DATA_S2_2 are data that has to be written earlier than the third sequence data DATA_S3.

The second sequence data DATA_S2_1 and DATA_S2_2 may be data that does not require ordered writing. In this case, different sequence numbers are assigned to the second sequence data DATA_S2_1 and DATA_S2_2, respectively.

That is, a plurality of sequence data (e.g., DATA_S2_1 and DATA_S2_2) have to be placed between preceding sequence data (e.g., DATA_S10 and following sequence data (e.g., DATA_S3), but it is unnecessary to guarantee an order among the plurality of sequence data (e.g., DATA_S2_1 and DATA_S2_2). Nevertheless, after writing of one sequence data (e.g., DATA_S2_1) is completed, the host device 100 sends a write request on the other sequence data (e.g., DATA_S2_1) to the storage device 200.

FIG. 13 shows another embodiment in which sequence numbers are assigned to sequence data. Referring to FIGS. 1, 4, and 13, first sequence data DATA_S1 is data that has to be written earlier than second sequence data DATA_S2_1 and DATA_S2_2. The second sequence data DATA_S2_1 and DATA_S2_2 are data that has to be written earlier than the third sequence data DATA_S3.

The second sequence data DATA_S2_1 and DATA_S2_2 may be data that does not require ordered writing. In this case, the same sequence number is assigned to the second sequence data DATA_S2_1 and DATA_S2_2, respectively.

In this embodiment, counts are assigned to the sequence data DATA_S1, DATA_S2_1, DATA_S2_2, and DATA_S3, respectively. When sequence numbers are duplicated, the counts denote the number of write requests having a duplicated sequence number. A count is included in a write request and then is sent to a storage device 200 from a host device 100.

In exemplary embodiments, write requests with the same sequence number may be together transmitted from the storage device 200 to the host device 100 regardless of whether the writing of one of them is complete. The host device 100 determines whether write operations corresponding to write requests with the same sequence number are all completed, depending on a count.

That is, a plurality of sequence data (e.g., DATA_S2_1 and DATA_S2_2) have to be placed between preceding sequence data (e.g., DATA_S10 and following sequence data (e.g., DATA_S3), but it is unnecessary to guarantee an order among the plurality of sequence data (e.g., DATA_S2_1 and DATA_S2_2). In this case, even though writing of one sequence data (e.g., DATA_S2_1) is not completed, the storage device 200 is allowed to send a write request on the other sequence data (e.g., DATA_S2_1) to the host device 100.

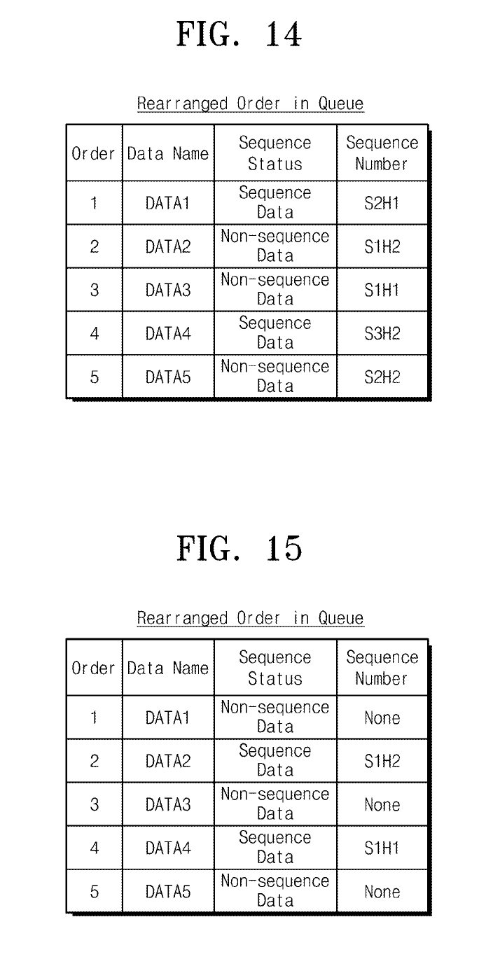

FIG. 14 shows another embodiment of write requests registered at a queue 322. Referring to FIGS. 1, 4, and 14, each write request has a sequence number. Each sequence number includes order identification information and host identification information. For example, a number placed next to ‘S’ may indicate the order identification information, and a number placed next to ‘H’ may indicate the host identification information.

The host identification information may indicate which host device issues a write request. For example, a storage device 200 may operate in a multi-host environment. Each of multiple hosts may transmit write requests on sequence data to the storage device 200. The storage device 200 independently manages write progress of write requests of the multiple hosts. The storage device 200 manages a first value and a second value to be notified to respective multiple hosts.

For example, the storage device 200 may manage a first value R1H1 to be notified to a first host and a first value R1H2 to be notified to a second host. The storage device 200 updates a first value R1H1 and a second value R2H1 to be notified to the first host, depending on sequence numbers S1H1 and S2H1 of write requests transmitted from the first host. The storage device 200 updates a first value R1H2 and a second value R2H2 to be notified to the second host, depending on sequence numbers S1H2, S2H2, and S3H2 of write requests transmitted from the second host.

FIG. 15 shows still another embodiment of write requests registered at a queue 322.

Referring to FIGS. 1, 4, and 15, write requests, associated with sequence data, from among write requests have sequence numbers. Each sequence number includes order identification information and host identification information. For example, a number placed next to ‘S’ may indicate the order identification information, and a number placed next to ‘H’ may indicate the host identification information

As described above, a host device 100 and a storage device 200 according to an embodiment of the disclosure may guarantee an order of sequence data by means of sequence numbers assigned to the write requests on the sequence data. Even though a write request on sequence data is transmitted to the storage device 200, the host device 100 and the storage device 200 perform normal communications except the write request on the sequence data.

In a conventional case, a host device is configured to transmit a flush request to a storage device after sending a write request on sequence data to the storage device. In response to the flush request, the storage device does not communicate with the host device until write operations on all write requests registered at a queue are completed. That is, in the conventional case, whenever a write event on sequence data is issued, communications between the host device and the storage device are interrupted and a flush operation is performed.

With an embodiment of the disclosure, an order of a plurality of write data is guaranteed as the host device 100 and the storage device 200 operate normally, thereby making it possible to improve operating speed of the host device 100 and the storage device 200.

In exemplary embodiments, a range of sequence numbers assigned to write requests may be finite. As sequence numbers are used for assignment, a sequence number may reach the upper limit. In this case, after sending a flush request to the storage device 200, the host device 100 resets sequence numbers. As another embodiment, the host device 100 may reset sequence numbers without sending a flush request to the storage device 200.

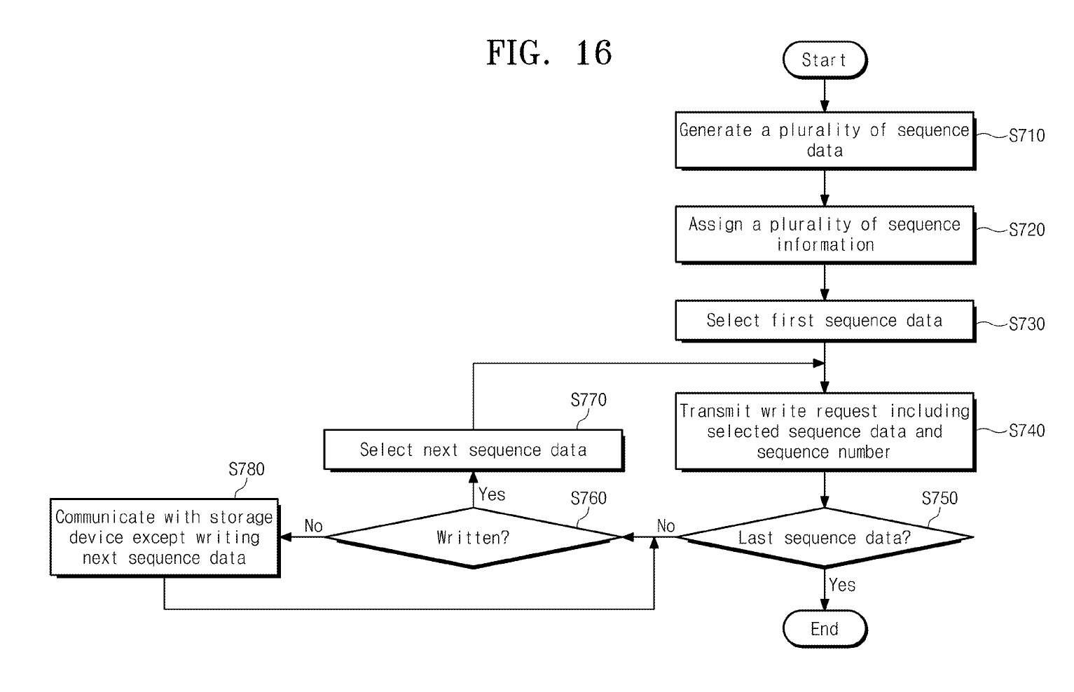

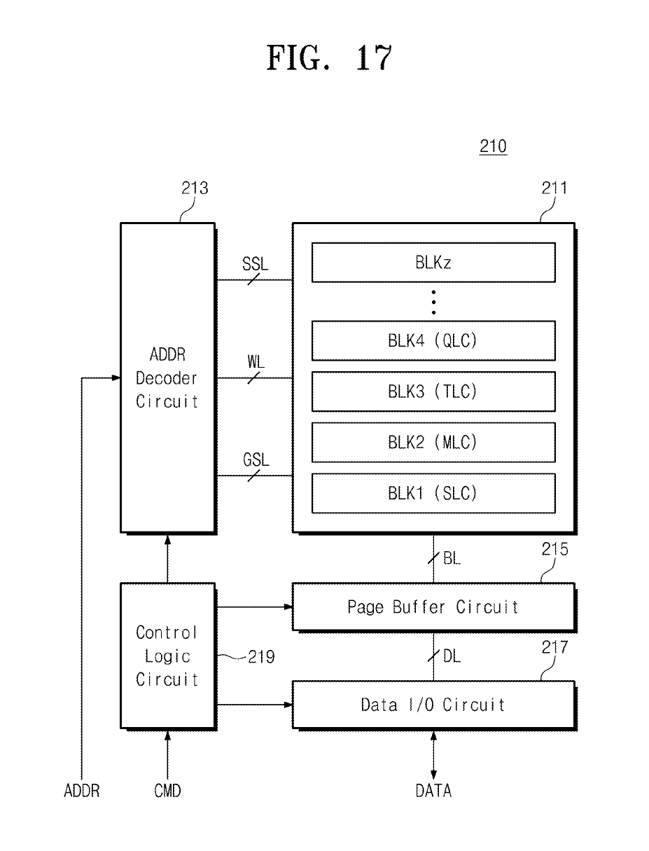

FIG. 16 is a flow chart schematically illustrating an operating method of a host device 100, according to another embodiment of the disclosure. Referring to FIGS. 1 and 16, in step S710, a host device 100 generates a plurality of sequence data. In step S720, the host device 100 assigns a plurality of sequence information to the plurality of sequence data, respectively. In step S730, the host device 100 selects a first one of the plurality of sequence data.

In step S740, the host device 100 transmits a write request, including the selected sequence data and sequence information assigned to the selected sequence data, to a storage device 200.

In step S750, the host device 100 determines whether transmitted sequence data is the last sequence data. If the transmitted sequence data is the last sequence data, writing of sequence data ends without additional control. That is, if a write request on the last sequence data is sent to the storage device 200, the host device 100 stops a control operation even though a write operation on the last sequence data is not completed. The reason is that the host device 100 regards an order of sequence data as being guaranteed.

If the transmitted sequence data is not the last sequence data, in step S760, the host device 100 determines whether writing of sequence data at the storage device 200 ends.

As a consequence of determining that writing of sequence data at the storage device 200 does not end, in step S780, the host device 100 communicates with the storage device 200 without transmitting next sequence data.

As a consequence of determining that writing of sequence data at the storage device 200 ends, in step S770, the host device 100 selects a next one of the plurality of sequence data. Afterwards, the method proceeds to step S740.

FIG. 17 is a block diagram schematically illustrating a nonvolatile memory 210 according to an embodiment of the disclosure. Referring to FIG. 17, a nonvolatile memory 210 includes a memory cell array 211, an address decoder circuit 213, a page buffer circuit 215, a data input/output circuit 217, and a control logic circuit 219.

The memory cell array 211 includes a plurality of memory blocks BLK1 through BLKz, each of which has a plurality of memory cells. Each memory block is connected to the address decoder circuit 213 through at least one string selection line SSL, a plurality of word lines WL, and at least one ground selection line GSL. Each memory block is connected to the page buffer circuit 215 through a plurality of bit lines BL. The memory blocks BLK1 through BLKz may be connected in common to the plurality of bit lines BL. Memory cells of the memory blocks BLK1 through BLKz may have the same structure.

The address decoder circuit 213 is connected to the memory cell array 211 through a plurality of ground selection lines GSL, the plurality of word lines WL, and a plurality of string selection lines SSL. The address decoder circuit 213 operates in response to a control of the control logic circuit 219. The address decoder circuit 213 receives an address ADDR from a memory controller 220 (refer to FIG. 4). The address decoder circuit 213 decodes the address and controls voltages to be applied to the word lines WL, depending on the decoded address. For example, at programming, the address decoder circuit 213 applies a pass voltage to word lines under the control of the control logic circuit 219. Also, the address decoder circuit 213 applies a program voltage to a word line, which the address points out, from among the word lines under the control of the control logic circuit 219.

The page buffer circuit 215 is connected to the memory cell array 211 through the bit lines BL. The page buffer circuit 215 is connected to the data input/output circuit 217 through a plurality of data lines DL. The page buffer circuit 215 operates in response to a control of the control logic circuit 219.

The page buffer circuit 215 holds data to be programmed at memory cells of the memory cell array 211 or data read from memory cells thereof. During a program operation, the page buffer circuit 215 stores data to be stored in memory cells. The page buffer circuit 215 biases the plurality of bit lines BL, based on the stored data. The page buffer circuit 25 functions as a write driver at a program operation. During a read operation, the page buffer circuit 215 senses voltages of the bit lines BL and stores the sensed results. The page buffer circuit 215 functions as a sense amplifier at a read operation.

The data input/output circuit 217 is connected to the page buffer circuit 215 through the data lines DL. The data input/output circuit 217 exchanges data with the memory controller 120.

The data input/output circuit 217 temporarily stores data DATA the memory controller 120 provides, and it transfers the temporarily stored data to the page buffer circuit 215. The data input/output circuit 217 temporarily stores data transferred from the page buffer circuit 215 and transfers it to the memory controller 220. The data input/output circuit 217 functions as a buffer memory.

The control logic circuit 219 receives a command CMD from the memory controller 220. The control logic circuit 219 decodes the command CMD thus received and controls an overall operation of the nonvolatile memory 210, depending on the decoded command. The control logic circuit 219 may receive a variety of control signals and voltages from the memory controller 220.

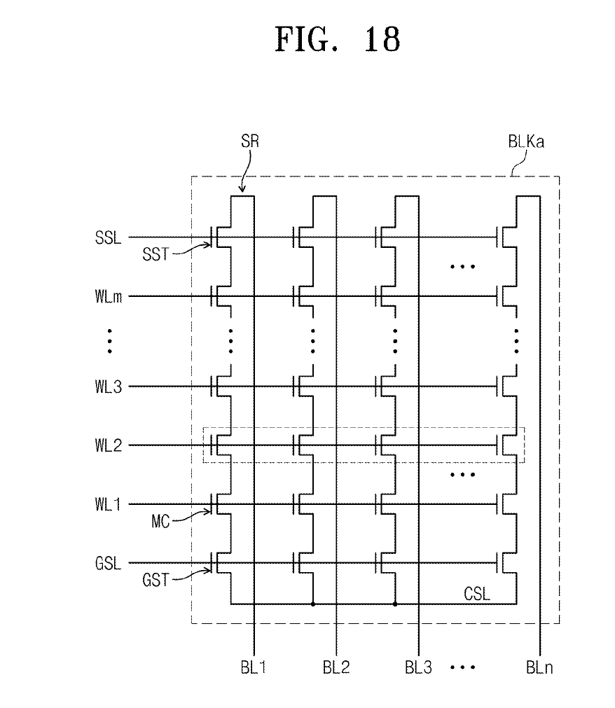

FIG. 18 is a circuit diagram schematically illustrating a memory block BLKa according to an embodiment of the disclosure. Illustrated in FIG. 18 is one BLKa of a plurality of memory blocks BLK1 through BLKz of a memory cell array 211 shown in FIG. 17.

Referring to FIG. 18, a memory block BLKa includes a plurality of strings SR, which are connected to a plurality of bit lines BL1 through BLn, respectively. Each string SR contains a ground selection transistor GST, memory cells MC, and a string selection transistor SST.

In each string SR, the ground selection transistor GST is connected between the memory cells MC and a common source line CSL. The ground selection transistors GST of the strings SR are connected in common to the common source line CSL and ground select line GSL.

In each string SR, the string selection transistor SST is connected between the memory cells MC and a bit line BL. The string selection transistors SST of the strings SR are connected to a plurality of bit lines BL1 through BLn, respectively. The string selection transistors SST of the strings SR are connected in common to a string select line SSL.

In each string SR, the plurality of memory cells MC are connected between the ground selection transistor GST and the string selection transistor SST. In each string SR, the plurality of memory cells MC are connected in series.

In the strings SR, memory cells MC having the same height from the common source line CSL are connected in common to a word line.

The memory cells MC of the strings SR are connected to a plurality of word lines WL1 through WLm.

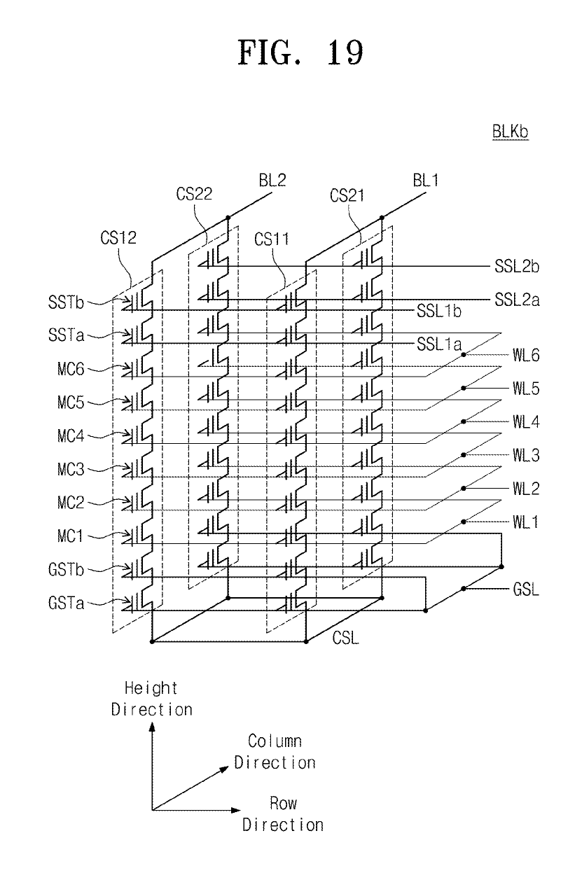

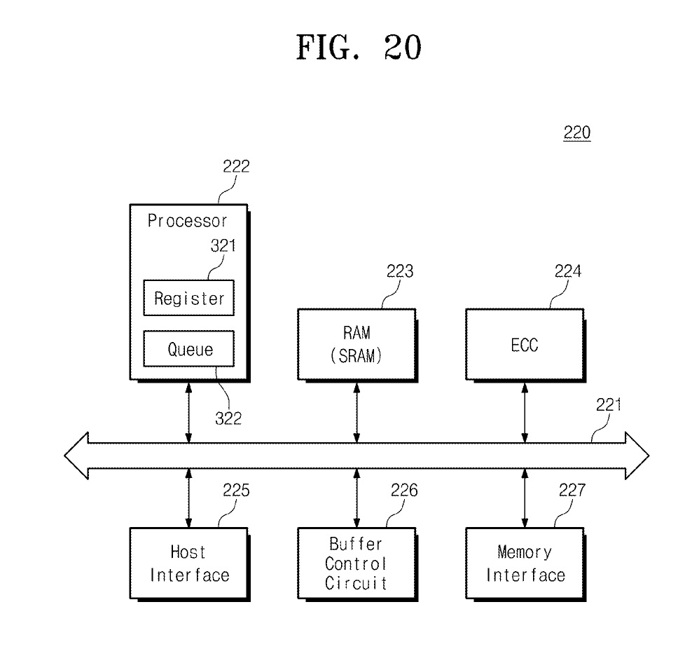

FIG. 19 is a circuit diagram schematically illustrating a memory block BLKb according to another embodiment of the disclosure. Referring to FIG. 19, a memory block BLKb includes a plurality of cell strings CS11 through CS21 and CS12 through CS22. The plurality of cell strings CS11 through CS21 and CS12 through CS22 are arranged along a row direction and a column direction and form rows and columns.

For example, the cell strings CS11 and CS12 arranged along the row direction form a first row, and the cell strings CS21 and CS22 arranged along the row direction form a second row. The cell strings CS11 and CS21 arranged along the column direction form a first column, and the cell strings CS12 and CS22 arranged along the column direction form a second column.

Each cell string contains a plurality of cell transistors. The cell transistors include ground selection transistors GSTa and GSTb, memory cells MC1 through MC6, and string selection transistors SSTa and SSTb. The ground selection transistors GSTa and GSTb, memory cells MC1 through MC6, and string selection transistors SSTa and SSTb of each cell string are stacked in a height direction perpendicular to a plane (e.g., plane above a substrate of the memory block BLKb) on which the cell strings CS11 through CS21 and CS12 through CS22 are arranged along rows and columns.

Each cell transistor may be formed of a charge trap type cell transistor of which the threshold voltage varies with the amount of charge trapped in its insulation layer.

Lowermost ground selection transistors GSTa are connected in common to a common source line CSL.

The ground selection transistors GSTa and GSTb of the plurality of cell strings CS11 through CS21 and CS12 through CS22 are connected in common to a ground selection line GSL.

In exemplary embodiments, ground selection transistors with the same height (or, order) may be connected to the same ground selection line, and ground selection transistors with different heights (or, orders) may be connected to different ground selection lines. For example, the ground selection transistors GSTa with a first height are connected in common to a first ground selection line, and the ground selection transistors GSTb with a second height are connected in common to a second ground selection line.

In exemplary embodiments, ground selection transistors in the same row may be connected to the same ground selection line, and ground selection transistors in different rows may be connected to different ground selection lines. For example, the ground selection transistors GSTa and GSTb of the cell strings CS11 and CS12 in the first row are connected in common to the first ground selection line and the ground selection transistors GSTa and GSTb of the cell strings CS21 and CS22 in the second row are connected in common to the second ground selection line.

Connected in common to a word line are memory cells that are placed at the same height (or, order) from the substrate (or, the ground selection transistors GST). Connected to different word lines WL1 through WL6 are memory cells that are placed at different heights (or, orders). For example, the memory cells MC1 are connected in common to the word line WL1, the memory cells MC2 are connected in common to the word line WL2, and the memory cells MC3 are connected in common to the word line WL3.

The memory cells MC4 are connected in common to the word line WL4, the memory cells MC5 are connected in common to the word line WL5, and the memory cells MC6 are connected in common to the word line WL6.

In first string selection transistors SSTa, having the same height (or, order), of the cell strings CS11 through CS21 and CS12 through CS22, the first string selection transistors SSTa in different rows are connected to different string selection lines SSL1a and SSL2a. For example, the first string selection transistors SSTa of the cell strings CS11 and CS12 are connected in common to the string selection line SSL1a, and the first string selection transistors SSTa of the cell strings CS21 and CS22 are connected in common to the string selection line SSL2a.

In second string selection transistors SSTb, having the same height (or, order), of the cell strings CS11 through CS21 and CS12 through CS22, the second string selection transistors SSTb in different rows are connected to the different string selection lines SSL1a and SSL2a. For example, the second string selection transistors SSTb of the cell strings CS11 and CS12 are connected in common to the string selection line SSL1b, and the second string selection transistors SSTb of the cell strings CS21 and CS22 are connected in common to the string selection line SSL2b.

That is, cell strings in different rows may be connected to different string selection lines. String selection transistors, having the same height (or, order), of cell strings in the same row may be connected to the same string selection line. String selection transistors, having different heights (or, orders), of cell strings in the same row may be connected to different string selection lines.

In exemplary embodiments, string selection transistors of cell strings in the same row may be connected in common to a string selection line. For example, string selection transistors SSTa and SSTb of cell strings CS11 and CS12 in the first row are connected in common to a string selection line, and string selection transistors SSTa and SSTb of cell strings CS21 and CS22 in the second row are connected in common to a string selection line.

Columns of the cell strings CS11 through CS21 and CS12 through CS22 are connected to different bit lines BL1 and BL2, respectively. For example, string selection transistors SSTb of the cell strings CS11 and CS21 in the first column are connected in common to the bit line BL1, and string selection transistors SSTb of the cell strings CS12 and CS22 in the second column are connected in common to the bit line BL2.

The memory block BLKa shown in FIG. 19 is exemplary and the disclosure is not limited thereto. For example, the number of rows of cell strings may increase or decrease. If the number of rows of cell strings is changed, the number of string or ground selection lines and the number of cell strings connected to a bit line may also be changed.

The number of columns of cell strings may increase or decrease. If the number of columns of cell strings is changed, the number of bit lines connected to columns of cell strings and the number of cell strings connected to a string selection line may also be changed.

A height of the cell strings may increase or decrease. For example, the number of ground selection transistors, memory cells, or string selection transistors that are stacked in each cell string may increase or decrease.

In exemplary embodiments, a read operation and a write operation may be performed by the row. The cell strings CS11 through CS21 and CS12 through CS22 may be selected by the row by means of the string selection lines SSL1a, SSL1b, SSL2a, and SSL2b.

In a selected row, a read operation and a write operation may be conducted by the word line. In the selected row, memory cells connected to a selected word line may be programmed.

In an embodiment of the present disclosure, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an embodiment of the present disclosure, the 3D memory array includes vertical NAND strings that are vertically oriented such that at least one memory cell is located over another memory cell. The at least one memory cell may comprise a charge trap layer. Each vertical NAND string further includes at least one select transistor located over memory cells, the at least one select transistor having the same structure with the memory cells and being formed monolithically together with the memory cells.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

FIG. 20 is a block diagram schematically illustrating a memory controller 220 according to an embodiment of the disclosure. Referring to FIG. 20, a memory controller 220 contains a bus 221, a processor 222, a RAM 223, an ECC block 224, a host interface 225, a buffer control circuit 226, and a memory interface 227.

The bus 221 may be configured to provide a channel among components of the memory controller 220.

The processor 222 controls an overall operation of the memory controller 220 and executes a logical operation. The processor 222 communicates with an external host device 100 (refer to FIG. 1) through the host interface 225. The processor 222 stores, in the RAM 223, a command or an address received through the host interface 225. The processor 222 outputs data from the host interface 225 through the buffer control circuit 226 or stores it at the RAM 223. The processor 222 produces an internal command and an address by means of a command or an address stored in the RAM 223 and outputs the internal command and address through the memory interface 227. The processor 222 outputs, through the memory interface 227, data stored in the RAM 223 or data received through the buffer control circuit 226. The processor 222 stores data received through the memory interface 227 at the RAM 223 or outputs it through the buffer control circuit 226. The processor 222 outputs, through the host interface 225 or the memory interface 227, data stored at the RAM 223 or data received through the buffer control circuit 226. In exemplary embodiments, the processor 222 may include a direct memory access (DMA) and may output data by means of the DMA.

The processor 222 contains a register 321 and a queue 322. The processor 222 registers writer requests or read requests received through the host interface 225 for management. The processor 222 stores the progress of write operations at the register 321. The processor 222 outputs information of the register 321 through the host interface 225, depending on a predetermined schedule or in response to a request received through the host interface 225.

The RAM 223 is used as a working memory, a cache memory, or a buffer memory of the processor 222. The RAM 223 stores codes or instructions that the processor 222 will execute. The RAM 223 stores data processed by the processor 222. The RAM 223 may include an SRAM.

The ECC block 224 performs an error correction operation. The ECC block 224 generates parity for error correction, based on data to be output through the memory interface 227. Data and parity may be output through the memory interface. The ECC block 224 corrects an error of received data by means of the received data and associated parity received through the memory interface 227.

The host interface 225 communicates with an external host device 100 (refer to FIG. 4) under the control of the processor 222. The host interface 225 may communicate through at least one of various communication manners, such as USB (Universal Serial Bus), SATA (Serial AT Attachment), HSIC (High Speed Interchip), SCSI (Small Computer System Interface), Firewire, PCI (Peripheral Component Interconnection), PCIe (PCI express), NVMe (NonVolatile Memory express), UFS (Universal Flash Storage), SD (Secure Digital), MMC (MultiMedia Card), and eMMC (embedded MMC).

The buffer control circuit 226 controls a RAM 230 (refer to FIG. 4) in response to a control of the processor 222. The buffer control circuit 226 writes data at the RAM 230 and reads data from the RAM 230.

The memory interface 227 is configured to communicate with the nonvolatile memory 510 in response to a control of the processor 522.

The memory controller 220 may be implemented with a system-on-chip (SoC).

In exemplary embodiments, a storage device 200 may not include the RAM 230. That is, the storage device 200 may not include a separate memory outside the memory controller 220 and a nonvolatile memory 210. In this case, the memory controller 220 may not include the buffer control circuit 226, and a function of the RAM 230 may be executed by the RAM 223 in the memory controller 220.

In exemplary embodiments, the processor 220 may control the memory controller 220 by means of codes. The processor 222 may load codes from a nonvolatile memory (e.g., read only memory) the memory controller 220 includes. As another embodiment, the processor 222 may load codes received from the memory interface 227.

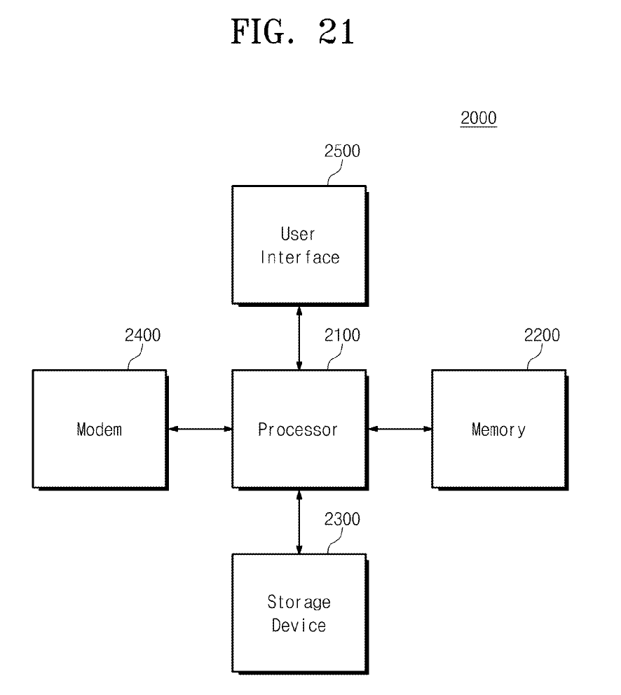

FIG. 21 is a block diagram schematically illustrating a computing device 2000 according to an embodiment of the disclosure. Referring to FIG. 21, a computing device 2000 includes a processor 2100, a memory 2200, a storage device 2300, a modem 2400, and a user interface 2500.

The processor 2100 controls an overall operation of the computing device 2000 and performs a logical operation. The processor 2100 is formed of a system-on-chip (SoC). The processor 2100 may be a general purpose processor, a specific-purpose processor, or an application processor.

As the memory 2200, a RAM 2200 communicates with the processor 2100. The RAM 2200 may be a main memory of the processor 2100 or the computing device 2000. The processor 2100 stores codes or data in the RAM 2200 temporarily. The processor 2100 executes codes using the RAM 2200 to process data. The processor 2100 executes a variety of software, such as, but not limited to, an operating system and an application, by means of the RAM 2200. The processor 2100 controls an overall operation of the computing device 2000 by means of the RAM 2200. The RAM 2200 may include a volatile memory such as, but not limited to, a static RAM, a dynamic RAM, and a synchronous DRAM or a nonvolatile memory such as, but not limited to, a Phase-change RAM (PRAM), a Magnetic RAM (MRAM), a Resistive RAM (RRAM), and a Ferroelectric RAM (FRAM).

The storage device 2300 communicates with the processor 2100. The storage device 2300 is used to store data for a long time. That is, the processor 2110 stores data, which is to be stored for a long time, in the storage device 2300. The storage device 2300 stores a boot image for driving the computing device 2000. The storage device 2300 stores source codes of a variety of software, such as an operating system and an application. The storage device 2300 stores data that is processed by a variety of software, such as an operating system and an application.

In exemplary embodiments, the processor 2100 loads source codes stored in the storage device 2300 on the RAM 2200. The codes loaded on the RAM 2200 are executed to run a variety of software, such as operating system and an application. The processor 2100 loads data stored in the storage device 2300 on the RAM 2200 and processes data loaded on the RAM 2200. The processor 2100 stores long-term data of data stored in the RAM 2200 at the storage device 2300.

The storage device 2300 includes a nonvolatile memory, such as, but not limited to, a flash memory, a PRAM (Phase-change RAM), an MRAM (Magnetic RAM), an RRAM (Resistive RAM), or an FRAM (Ferroelectric RAM).

The modem 2400 communicates with an external device according to a control of the processor 2100. For example, the modem 2400 communicates with the external device in a wire or wireless manner. The modem 2400 may communicate with the external device, based on at least one of wireless communications manners such as LTE (Long Term Evolution), WiMax, GSM (Global System for Mobile communication), CDMA (Code Division Multiple Access), Bluetooth, NFC (Near Field Communication), WiFi, and RFID (Radio Frequency Identification or wire communications manners such as USB (Universal Serial Bus), SATA (Serial AT Attachment), HSIC (High Speed Interchip), SCSI (Small Computer System Interface), Firewire, PCI (Peripheral Component Interconnection), PCIe (PCI express), NVMe (NonVolatile Memory express), UFS (Universal Flash Storage), SD (Secure Digital), SDIO, UART (Universal Asynchronous Receiver Transmitter), SPI (Serial Peripheral Interface), HS-SPI (High Speed SPI), RS232, I2C (Inter-integrated Circuit), HS-I2C, I2S, (Integrated-interchip Sound), S/PDIF (Sony/Philips Digital Interface), MMC (MultiMedia Card), and eMMC (embedded MMC).

The user interface 2500 communicates with a user under a control of the processor 2100. For example, the user interface 2500 may include user input interfaces such as a keyboard, a keypad, a button, a touch panel, a touch screen, a touch pad, a touch ball, a camera, a microphone, a gyroscope sensor, and a vibration sensor. The user interface 2500 may further include user output interfaces such as an LCD, an OLED (Organic Light Emitting Diode) display device, an AMOLED (Active Matrix OLED) display device, an LED, a speaker, and a motor.

The storage device 2300 may include a storage device 200 according to an embodiment of the disclosure. The processor 2100 may be a host device 100 according to an embodiment of the disclosure. That is, the processor 2100 assigns sequence numbers to write requests on sequence data. After a write operation on one sequence data ends, the processor 2100 sends a write request on next sequence data. The processor 2100 transmits a read request or a write request on non-sequence data, independently of a write request on sequence data. The storage device 2300 processes write requests and sends progress of the write requests to the processor 2100.

In exemplary embodiments, the processor as well as an external device that communicates with the modem 2400 or the computing device 2000 through the modem 2400 may operate as the host device 100.

While the disclosure has been described with reference to exemplary embodiments, it will be apparent to those skilled in the art that various changes and modifications may be made without departing from the spirit and scope of the disclosure. Therefore, it should be understood that the above embodiments are not limiting, but illustrative.

1. An operating method of a storage device, the method comprising:
receiving a plurality of write requests; and
executing write operations in response to the plurality of write requests, wherein
progress information on the degree of progress of the write operations is output while the write operations corresponding to the plurality of write requests are performed.

2. The operating method of claim 1, wherein the plurality of write requests include a plurality of sequence numbers corresponding to the plurality of write requests.

3. The operating method of claim 2, wherein the progress information comprises a sequence number of an oldest write request, not yet performed, from among the plurality of write requests.

4. The operating method of claim 3, wherein when the oldest write request is performed, the sequence number corresponding thereto is output as the progress information.

5. The operating method of claim 2, wherein the progress information comprises a sequence number of a write request, most recently performed, from among the plurality of write requests.

6. The operating method of claim 5, wherein upon performing each of the plurality of write requests, the sequence number corresponding thereto is output as the progress information.

7. The operating method of claim 2, further comprising:
receiving a target sequence number, wherein
when a sequence number corresponding to a most recently performed write request is the same as the target sequence number, an interrupt indicating the sameness is output as the progress information.

8. The operating method of claim 1, wherein at least one of the plurality of write requests comprises a sequence number.

9. The operating method of claim 8, wherein when a write operation corresponding to the at least one write request having the sequence number is performed, the sequence number is output as the progress information.

10. The operating method of claim 1, wherein the progress information is output in response to a read request received from an external device.

11. A method of writing data at a storage device, the method comprising:
transmitting a write request for first sequence data to the storage device; and
transmitting a write request on second sequence data to the storage device in response to an input of progress information indicating that a write operation on the first sequence data has ended, wherein:
the first sequence data is data that has to be written at the storage device earlier than the second sequence data,
a read operation, in which data is read from the storage device, or a write operation, in which non-sequence data is written at the storage device, is conducted until the write operation on the first sequence data ends, and
the non-sequence data is data that is to be written at the storage device regardless of an order.

12. The method of claim 11, wherein:
each of write requests transmitted to the storage device includes a sequence number, and
when the progress information includes a sequence number of the write request for the first sequence data, the write operation for the first sequence data is determined as being completed.

13. The method of claim 11, wherein:
each of write requests transmitted to the storage device includes a sequence number, and
when a value of the progress information is equal to or greater than a sequence number of the write request for the first sequence data, the write operation for the first sequence data is determined as being completed.

14. The method of claim 11, wherein:
the write request, associated with the first sequence data, from among write requests transmitted to the storage device includes a sequence number, and
when the progress information includes the sequence number of the write request for the first sequence data, the write operation for the first sequence data is determined as being completed.

15. The method of claim 11, wherein the progress information is acquired by sending a read request on the progress information periodically.

16-20. (canceled)

21. A method, executed by a memory controller, of writing sequential data to a nonvolatile memory, the method comprising:
a) receiving, from a host computing device, a write request comprising first data and sequence information assigned to the first data, the first data being selected from among the first data and second data that must be written to the nonvolatile memory in the order of the first data and then the second data;
b) writing the first data to the nonvolatile memory; and
c) transmitting, to the host computing device, an indication that the first data has been written to the nonvolatile memory.

22. The method of claim 21, wherein the indication is an interrupt signal.

23. The method of claim 21, wherein the indication comprises the sequence information.

24. The method of claim 21, wherein the set of operations (a) through (c) are performed for each of multiple hosts.

25-33. (canceled)

34. The method of claim 21, wherein third data having no order related with the first data and the second data are written to the nonvolatile memory regardless the indication.
